(19) United States
(12) Patent Application Publication
(10) Pub. No.: US 2009/0279946 A1
(43) Pub. Date: Nov. 12, 2009

(54) SHAFT COUPLING DEVICE

(75) Inventors: Paul Wingett, Mesa, AZ (US); Steve Abel, Chandler, AZ (US); Eric J. Ekstrom, Peoria, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/184,509

(22) Filed: Aug. 1, 2008

Related U.S. Application Data
(60) Provisional application No. 61/052,032, filed on May 9, 2008.

(51) Int. Cl. F16D 1/033

(52) U.S. Cl. 403/312

(57) ABSTRACT

An apparatus is provided for a shaft coupling device. The shaft coupling device comprises first and second portions adapted to be coupled together, the first and second portions having a cavity when formed, the cavity adapted to receive two shaft ends, at least one interior wall of the cavity having a frustrum-shaped surface, and the two shaft ends each having at least one spherical-shaped surface.

### CROSS-REFERENCE TO RELATED APPLICATION(S)

This application claims the benefit of U.S. provisional patent application Ser. No. 61/052,032, filed May 9, 2008.

### TECHNICAL FIELD

Embodiments of the subject matter described herein relate generally to coupling devices. More particularly, embodiments of the subject matter relate to coupling devices for coaxial shafts.

### BACKGROUND

Systems that include axial transmission of force sometimes rely on two different shafts coupled to each other. Transmission of force then occurs when the end of one shaft moves against the end of the other. In some systems, it is highly desirable to transmit only the axial force, without torsional or non-axial force components. Accordingly, it is advantageous to couple two shafts together in such a manner that only axial translational force is imparted from one to another.

### BRIEF SUMMARY

A shaft coupling assembly is provided. The assembly comprises a channeled portion having a substantially semi-cylindrical shape along a longitudinal axis and a channel extending at least partially through the portion along the longitudinal axis and a solid portion having a substantially semi-cylindrical shape and adapted to couple with the channeled portion to enclose a cavity.

A shaft coupling device for coupling a first end of a first shaft and a second end of a second shaft, each shaft extending along substantially the same central axis is also provided. The shaft coupling device comprises a first portion and a second portion adapted to form a cavity when joined together, the cavity adapted to receive two shaft ends, the cavity having at least two frustum-shaped surfaces and a plurality of fastening members adapted to join the first and second portions.

A coupling assembly is also provided. The assembly comprises a first shaft comprising a first shaft end, a second shaft comprising a second shaft end, and a coupling device comprising a first portion and a second portion adapted to couple with the first portion to surround a cavity having at least one frustum-shaped surface.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a perspective view of an embodiment of a shaft coupling device;

FIG. 2 is a cutaway perspective view of the embodiment of FIG. 1;

FIG. 3 is cross-sectional view of the embodiment of FIG. 1;

FIG. 4 is a perspective view of an embodiment of two components of the shaft coupling device of FIG. 1;

FIG. 5 is a perspective view of an embodiment of a channeled portion of the shaft coupling device of FIG. 1; and

FIG. 6 is a perspective view of an embodiment of the solid portion of the shaft coupling device of FIG. 1.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

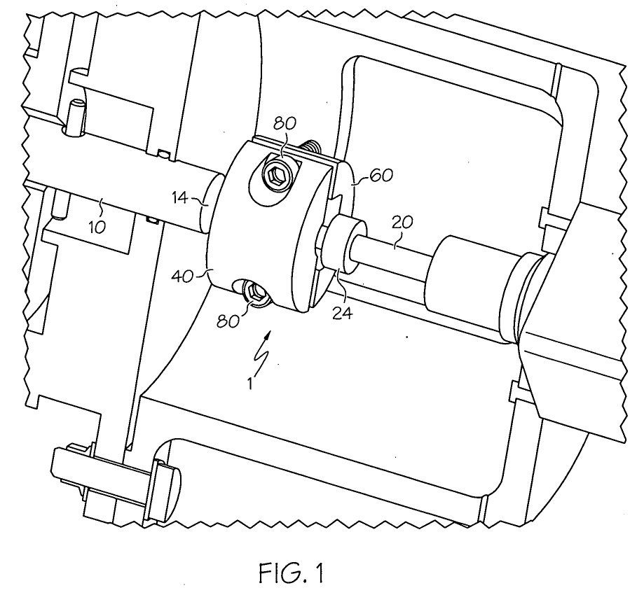

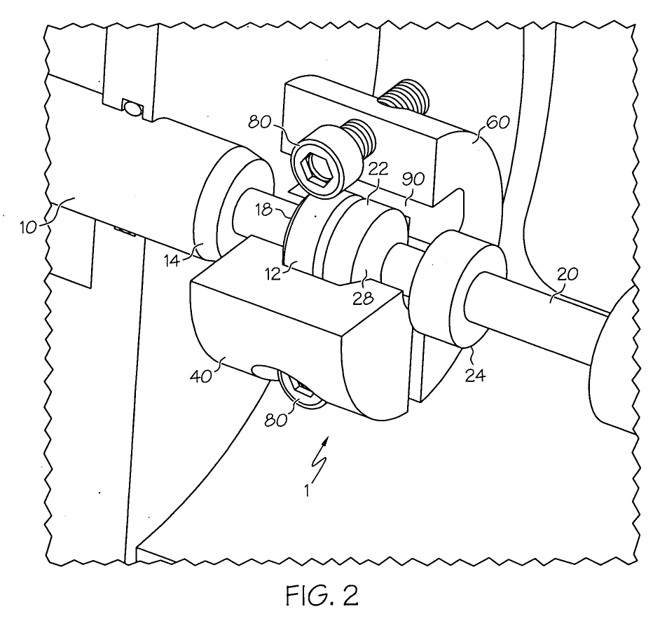

FIG. 1 illustrates a coupling device 1 adapted to enclose and influence the interaction between a first shaft 10 and a second shaft 20. FIG. 2 illustrates a cutaway view of the embodiment of FIG. 1. The coupling device 1 comprises a solid portion 40 and a channeled portion 60. The solid and channeled portions 40, 60 can be attached by one or more fastening members 80, such as screws, bolts, threaded rods, and the like. Although the illustrated embodiment depicts two such fastening members 80, more or fewer can also be used. The fastening members 80 can extend through holes or ports in either the solid or channeled portions 40, 60 or both.

As shown, the first and second shafts 10, 20 are preferably substantially co-axial. Either or both of the two shafts 10, 20 can be a component of or attached to a position-altering device, such as a pneumatic actuator, an electromagnetic motor or other axially-translating, force-imparting device. Preferably, each of the shafts 10, 20 terminates in a shaft end 12, 22 having properties and features which will be described in greater detail below, and comprises a retention flange 14, 24. The retention flange 14, 24 can be either a widening in the shaft diameter, as in the case of the first retention flange 14, an element of the first shaft 10 or a protrusion as in the case of the second retention flange 24, an element of the second shaft 20. In some embodiments, a shaft can comprise several coupled components, such as shaft and flange portions coupled together, or it can be an integral shaft comprising the various features. As one example of a shaft composed of different components, the shaft end, retention flange, or connecting rod-shaped components can be separate shaft elements joined through screws or other fastening members, pinning, welding, brazing, glue or other bonding agents, or any other suitable method.

The coupling device 1 preferably constrains axial separation of the shaft ends 12, 22. Accordingly, when the solid portion 40 and channeled portion 60 are joined with the fastening members 80, the two portions 40, 60 preferably form a substantially cylindrical device. In some embodiments, at least one of the fastening members 80 can be received by a slotted bolt hole 92, allowing one member 80 to be secured and the coupling device 1 positioned before securing one or more additional fastening members 80. Non-slotted bolt holes 94 can also be used, and any hole can be smooth or threaded, as appropriate for use with fastening members 80 in the embodiment.

Preferably, the first and second shafts 10, 20 have a narrow or indented portion between the retention flanges 14, 24 and the shaft ends 12, 22. The coupling device 1 can occupy at least a portion of the indented area of each shaft 10, 20. Additionally, when joined, the solid and channeled portions 40, 60 can have an internal cavity 90 suitably large to contain the shaft ends 12, 22.

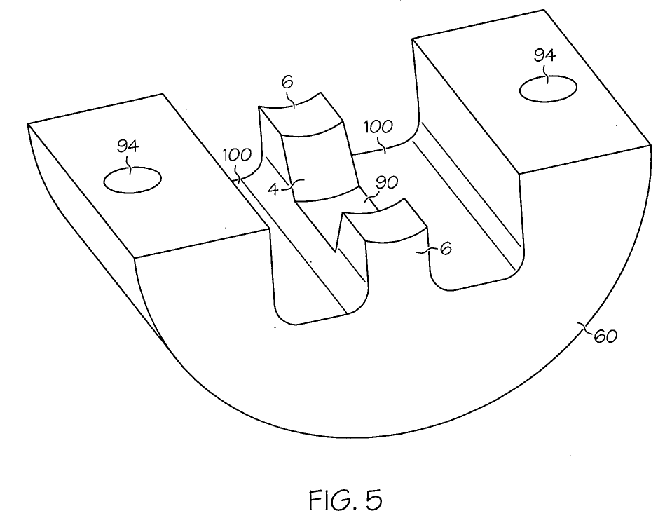

In addition to constraining axial separation, the coupling device 1 preferably permits at least some non-axial movement of the shafts 10, 20. With reference to FIG. 5, a perspective view of the channeled portion 60 coupling device 1 is shown. The channels 100 in the channeled portion 60 are a groove extending at least partially, and preferably entirely, axially through the portion 60. Because the volume of opened material comprising the channels 100 is contiguous with the cavity 90, one of the shaft ends 12, 22 is permitted to be offset from the center of the other shaft, by sliding towards one or both of the channels 100. Accordingly, shafts which are not axially aligned can be coupled together with the coupling device 1, permitting off-aligned shafts to retain their original positions. Preferably, the coupling device 1 does not impart a force on the shaft in a direction transverse to the axial direction of the shaft to couple the shafts. In some embodiments, the channels 100 can be replaced with portions of a compressible material, such as an elastomeric or plastically-deforming material, thereby permitting the same off-alignment axis positioning.

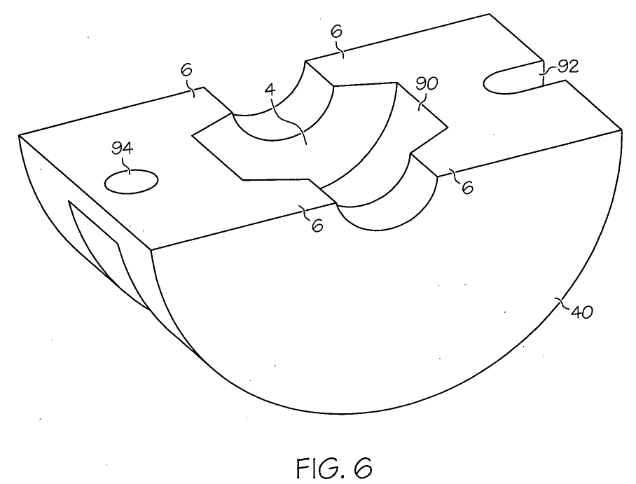

FIG. 6 shows a perspective view of the solid portion 40. The cavity 90 is shown with the securing surface 4 visible. As shown, one bolt hole can be slotted 94 on the solid portion 40. Accordingly, insertion and rotation of the final fastening member 80 can be facilitated by permitting a varying entry angle or allowing partial engagement of the fastening member 80 prior to final positioning of the solid portion 40 relative to the channeled portion 60.

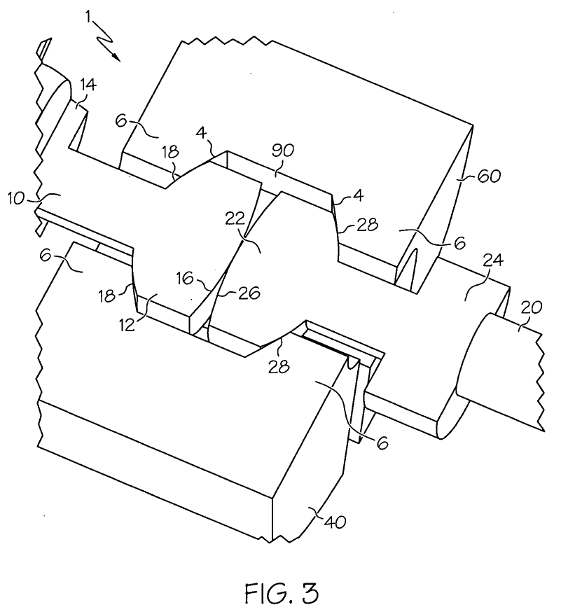

With reference to FIG. 3, a cross-sectional view of the coupling device 1 and shafts 10, 20 is shown, including a cross-section of the shaft ends 12, 22 and retention flanges 14, 24. As can be seen, the coupling device 1 preferably engages both shafts 10, 20 between their respective shaft ends 12, 22 and retention flanges 14, 24. The securing portions 6 of the coupling device 1 can extend substantially entirely around both shafts 10, 20.

Each side of a shaft can contact a securing surface 4. The securing surfaces 4 can be the inner wall of the securing portion 6, which is also a surface of the cavity 90. Accordingly, each shaft end 12, 22 can be constrained from separating axially by the securing surface 4. Each securing surface 4 preferably has a frustrum shape corresponding to a circular cone. In some embodiments, different geometric shapes for the frustum can be used, including quadrilateral, pentagonal, hexagonal, and so on. At least the securing surfaces 4, and preferably the entire coupling device 1, are composed of a metal with suitable hardness to prevent the shaft ends 12, 22 from indenting the surfaces 4. Such metals can include titanium, stainless steel, brass and some brass alloys, aluminum, and some aluminum alloys, and so on.

In addition to the frustrum-shaped securing surfaces 4, the shaft ends 12, 22 preferably are shaped to have a spherical surface. Thus, each shaft end 12, 22 comprises two engagement surfaces. First, the shaft contact surfaces 16, 26 are disposed on the terminal side of the shaft ends 12, 22. The shaft contact surfaces 16, 26 can contact each other for purpose of force transmission between the two shafts 10, 20. The shaft contact surfaces 16, 26 can be in constant contact, as constrained by the coupling device 1, or can have some separation, if desired. Preferably, the shaft contact surfaces 16, 26 have a spherical surface shape. The shaft ends 12, 22 can each have a coupling contact surface 18, 28, also having a spherical surface shape extending around the contact surface.

Thus, preferably, the coupling device 1 can enforce the connection between the two shafts 10, 20, preventing undesired axial separation between the shaft contact surfaces 16, 26. The coupling device 1 can constrain axial movement of the shafts 10, 20 which could potentially result in separation between the shaft ends 12, 22 by forming an interference fit between the securing surfaces 4 along the interior of the cavity 90 and the coupling contact surfaces 18, 28. The tightness of the interference fit can be adjusted by adjusting the fastening members 80 securing the portions 40, 60 together.

Because contact between the two shafts 10, 20 occurs between two spherically-shaped surfaces, it is preferably constrained to a small contact area. Accordingly, torsional forces are preferably inhibited from being transmitted between the shafts 10, 20. Additionally, because the coupling device 1 constrains axial shaft separation while permitting transverse movement of the shafts 10, 20, no moment forces can be transmitted across the spherical contact surface.

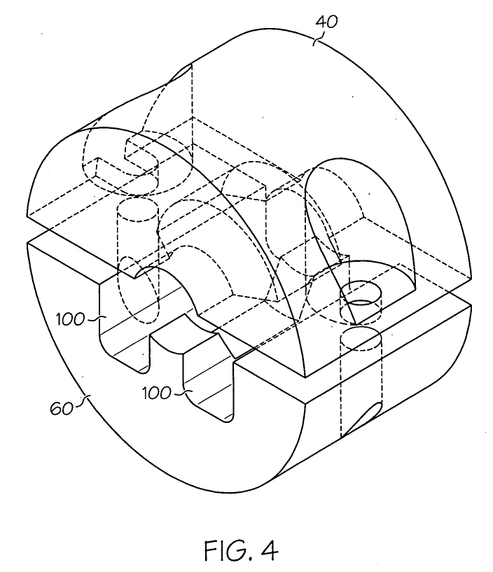

With reference to FIG. 4, a perspective view of the solid 40 and channeled 60 portions is shown, with phantom lines illustrating hidden features for clarity. As shown, the cavity portions 90 of both the solid and channeled 40, 60 portions can be substantially aligned to surround or enclose the shaft ends 12, 22.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A shaft coupling assembly comprising:
a channeled portion having a substantially semi-cylindrical shape along a longitudinal axis and a channel extending at least partially through the portion along the longitudinal axis; and
a solid portion having a substantially semi-cylindrical shape and adapted to couple with the channeled portion to enclose a cavity.

2. The shaft coupling assembly of claim 1, wherein the cavity comprises two frustum-shaped surfaces.

3. The shaft coupling assembly of claim 2, wherein the frustum-shaped surfaces have a conical shape.

4. The shaft coupling assembly of claim 1, wherein the shaft coupling assembly further comprises a plurality of fastening members adapted to join the channeled and solid portions.

5. The shaft coupling assembly of claim 4, wherein the channeled and solid portions each comprise a hole adapted to receive one of the plurality of fastening members.

6. The shaft coupling assembly of claim 5, wherein the hole comprises a slotted bolt hole.

7. The shaft coupling assembly of claim 1, wherein the channeled and solid portions are composed of stainless steel.

8. A shaft coupling device for coupling a first end of a first shaft and a second end of a second shaft, each shaft extending along substantially the same central axis, the shaft coupling device comprising:
a first portion and a second portion adapted to form a cavity when joined together, the cavity adapted to receive two shaft ends, the cavity having at least two frustum-shaped surfaces; and
a plurality of fastening members adapted to join the first and second portions.

9. The shaft coupling device of claim 8, wherein the first portion comprises a channel extending through the first portion in a direction parallel to the central axis.

10. The shaft coupling device of claim 8, wherein the first end of the first shaft comprises a spherical surface.

11. The shaft coupling device of claim 10, wherein the second end of the second shaft comprises a spherical surface.

12. The shaft coupling device of claim 8, wherein one of the plurality of fastening members extends through a slotted hole.

13. The shaft coupling device of claim 8, wherein the two frustum-shaped surfaces have a circular conical shape.

14. A coupling assembly comprising:
a first shaft comprising a first shaft end;
a second shaft comprising a second shaft end; and
a coupling device comprising:
a first portion; and
a second portion adapted to couple with the first portion to surround a cavity having at least one frustum-shaped surface.

15. The coupling assembly of claim 14, wherein each of the first and second shaft ends comprise an upper surface and a lower surface.

16. The coupling assembly of claim 15, wherein one surface of each of the first and second shaft ends comprises a spherically-shaped surface.

17. The coupling assembly of claim 14, wherein each of the first and second shafts have substantially the same central axis and the first portion comprises a channel extending substantially along the central axis.

18. The coupling assembly of claim 14, wherein at least one of the first and second shafts comprises a retention flange.
